(19) United States
(12) Patent Application Publication
(10) Pub. No.: US 2021/0230909 A1
(43) Pub. Date: Jul. 29, 2021

(54) SECURITY LOCK

(71) Applicant: ULTRAFAB (PROPRIETARY) LIMITED, Johannesburg (ZA)

(72) Inventor: Hendrik Johannes VAN NIEKERK, Florida Park (ZA)

(21) Appl. No.: 16/972,383

(22) PCT Filed: Jun. 4, 2019
(86) PCT No.: PCT/IB2019/054623

§ 371 Date: Dec. 4, 2020

(30) Foreign Application Priority Data
Jun. 4, 2018 (GB) 1809117.3

(51) Int. Cl. E05B 67/38; E05B 9/02

(52) U.S. Cl. CPC E05B 67/383; E05C 1/04; E05B 9/02

(57) ABSTRACT

This invention concerns a security lock for use with a lock unit. The security lock has a base, a casing in which the base is, in use, received, an elongate locking bolt, biasing means for urging the locking bolt towards its inoperative position, an externally accessible operating member for moving the locking bolt and a locking mechanism which is used to lock the bolt in its operative position. A securing mechanism is operable between a locked state in which the base and casing are locked to each other and a released state in which the base and casing are released from each other. A securing element is held captive such that it remains in position irrespective of whether the securing mechanism is in its locked or released state.

### BACKGROUND TO THE INVENTION

THIS invention relates to a security lock and more particularly, but not exclusively, to a security lock with a manually slidable bolt.

Security locks with manually operable sliding bolts as locking member are well-known in the industry. These security locks has proven to be very popular due to their improved security compared to other locks that have sliding bolts, particularly for use on a hinged type of security closure such as a hinged door or gate. The security lock typically has a casing, which is carried by the door or gate.

One variant of this known security lock is described in the specification of the applicant's earlier South African patent no. 2000/07382. This variant has locking plates which are movable into a locked state wherein they lock locking bolts in a position wherein they protrude from the lock casing. The locking plates are moved into their unlocked state to release the locking bolts through operating a key of a lock unit. In this variant the lock has a casing that includes two halves that are welded in a closed condition to prevent access to the internal mechanism of the lock.

Another variant of this known security lock is described in the specification of the applicant's earlier South African patent no. 2003/09024. This variant aims to address some shortcomings of the earlier one by allowing for the lock to be key operated from either side of the door or gate. For this reasons the lock has a double sided key operating lock unit in which the direction in which the key is received is perpendicular to the direction along which the sliding bolts moves. However, its casing is substantially similar to that of the lock of ZA 2000/07382 and has an inner and outer casing that are welded to one another.

In another variant of the sliding bolt type, the lock is adapted to accommodate padlock, which is mounted inside the casing such that its keyhole is aligned with an opening in the casing through which the key is receivable. The sliding bolt is movable between an outwardly projecting operative position and a withdrawn inoperative position. A spring-loaded locking mechanism engages the sliding bolt and shackle of the padlock such that movement of the sliding bolt from its inoperative withdrawn position into its operative protruding position moves the shackle into the body of the padlock so as to lock the padlock. This movement of the locking mechanism is triggered by pushing an externally accessible operating member into the casing. The operating member typically extends out of the casing in the opposite direction of the protruding sliding bolt. In order to unlock the sliding lock the key of the padlock is used to unlock the shackle of the padlock, which moves the sliding bolt back into its inoperative withdrawn position by means of the locking mechanism. The operating member is simultaneously moved out of the casing such that it is easily accessible by a user the next time the security lock has to be locked.

In this known security lock a torsion spring is used to urge the sliding bolt into its inoperative position, thereby withdrawing the bolt as the padlock is unlocked using the key. The use of the torsion spring is not ideal seeing that it causes a rotational force of the locking mechanism and therefore the sliding bolt and padlock. Furthermore, the sliding bolt is a composite component comprising a steel bolt and an aluminium sleeves carried by its end which protrudes from the casing when in its operative, locked position. The cost of manufacturing of the composite sliding bolt is therefore unnecessarily high.

Another disadvantage of this known security lock is that the padlock has to comply with strict design requirements in order for the security lock to function consistently without failure. Whenever the padlock needs to be replaced, either due to failure of the padlock or more likely due to misplaced keys, it is important to use a padlock that complies with the strict design requirements. In some instances the security lock may not function properly if a different padlock is used than the one originally installed by the manufacturer. This is largely due to misalignment resulting from the play between the locking mechanism and shackle of the padlock if a different padlock is used.

Unlike the locks of ZA 2000/07382 and ZA 2003/09024, in this subsequent variant of the lock its casing can be opened. However, a significant disadvantage of the known security lock is that it can be cumbersome and time consuming to disassemble and reassemble the security lock, which is required when replacing the padlock, for example. The base plate on which the locking mechanism, sliding bolt and padlock are mounted is fixed to the casing by means of a fastener, typically a threaded bolt. When assembled, the threaded bolt passes through an opening in an upstanding front wall of the base plate and is received in a threaded socket carried by the casing. When assembling the security lock, the fastener has to be aligned with the socket while the base plate is located in the casing. As a result of the end of the fastener located inside the casing not being visible to the person trying to assemble the lock, the person often spends a significant amount of time to locate the end of the threaded bolt in the socket prior to being able to fasten it. The lost time associated with the assembling of the lock is compounded when considering that the locks are commonly installed on security gates of high residency buildings.

It is accordingly an object of the invention to provide a security lock that will, at least partially, address the above disadvantages.

It is also an object of the invention to provide a security lock which will be a useful alternative to existing security locks.

### SUMMARY OF THE INVENTION

In accordance with a first aspect of the invention there is provided a security lock for use with a lock unit, the security lock including:
a base;
a casing in which the base is, in use, received;
an elongate locking bolt which is movable between an first, operative position in which the bolt project from the base and a second, inoperative position in which the bolt is substantially withdrawn;
biasing means for biasing the locking bolt towards the withdrawn inoperative position;
an externally accessible operating member extending from the casing and cooperating with the locking bolt to move it against its bias from its inoperative to its operative position, wherein the operating member is substantially inaccessible or ineffective when the locking bolt is in its operative position;
a locking mechanism for retaining the locking bolt in its operative position, wherein the locking mechanism in use engages the lock unit such that unlocking of the lock unit releases the locking mechanism to allow the locking bolt to move from its operative position to its inoperative position under the action of the biasing means; and
a securing mechanism for securing the base to the casing, wherein the securing mechanism includes a securing element which is operable to move the securing mechanism between a locked state in which the base and casing are locked to each other and a released state in which the base and casing are released from each other, wherein the securing element is held captive such that it remains in position irrespective of whether the securing mechanism is in its locked or released state.

The securing mechanism may include complementary shaped securing formations carried on the base and casing respectively such that relative movement between the securing formations in one direction secure the base and casing together and relative movement in the opposite direction releases the base from the casing.

The securing formation carried by the base may be held captive on the securing element such that rotation of the securing element in one direction causes rotation of the securing formation located on the base so as to engage the securing formation carried by the casing and rotation of the securing element in the opposite direction causes rotation of the securing formation carried by base in a direction releasing the securing formation from the securing formation carried by the casing.

Preferably, the securing element is in the form of a threaded fastener which is held captive by a threaded nut located thereon, and wherein rotation of the nut on the fasteners is obstructed by the securing formation carried by the base.

The securing formation on the base may be in the form of a substantially U-shaped channel section which is held captive on the threaded fastener between a spring and the nut threaded on the fastener.

The U-shaped channel is preferably shaped to allow partial rotation about the threaded fastener such that it engages the securing formation carried by the casing in one radial position and disengages the securing formation carried by the casing in another radial position.

The threaded fastener may be a bolt or screw, one end of which is secured in a threaded upstanding receiver plate located on the base and the other end is located on the outside of the upstanding front wall of the base such that the securing mechanism is operable from outside the casing.

The security lock may include a removable lock unit retaining and aligning formation for retaining and aligning the lock unit thereby to position the lock unit relative to the locking mechanism.

The lock retaining formation may be in the form of a metal plate housing.

The housing may have a lock unit engaging means for engaging and securing the lock to the housing.

The retaining means may be in the form of a lip carried at one end of the housing and a pair of recesses carried at a second opposite end of the housing. The recesses are preferably shaped to receive the shackle of the lock unit. The one recess may be in the form of a slot for receiving the fixed end of the shackle while the other recess may be in the form of a hole for receiving the free end of the shackle when the lock unit is in its locked state.

The metal housing and base may carry complementary shaped locating formations for locating the housing on the base. The locating formation on the metal housing may be in the form of a cut-out for receiving the locating formation in the form of an upstanding guide located on the base.

The locking bolt is preferably in the form of a single component.

The locking bolt may have a uniform diameter over substantially its entire length.

The security lock may include guide located on the base for guiding movement of the locking bolt.

The operating member preferably carries a stop formation for limiting its movement and, accordingly, the movement of the locking bolt, wherein the stop formation locates against the guide located on the base to limit movement of the locking bolt into its operative, locked position and locates against the internal surface of the casing to limit movement of the locking bolt into its inoperative, unlocking position.

The locking bolt carries a locking mechanism engaging member for engaging the locking mechanism, thereby allowing movement of the locking bolt to be transferred to the locking mechanism and vice versa. The locking mechanism engaging member may be in the form of a plate carried in a locating groove in the locking bolt.

The externally accessible operating member may be in the form of a sleeve, which is preferably cylindrical in shape, such that it is receivable about an end of the locking bolt.

The operating member may carry a stop formation for limiting its movement and, accordingly, the movement of the locking bolt. The stop formation may be in the form of a stop plate carried in a groove located on the sleeve. In use, the stop formation locates against a guide located on the base plate to limit movement of the locking bolt into its operative, locked position and located against the internal surface of the casing to limit movement of the locking bolt into its inoperative, unlocking position.

The locking mechanism is preferably shaped to engage the locking member engaging member located on the locking bolt at one end and to engage the shackle of the lock unit at its other end.

The locking mechanism may be pivotally mounted on the base plate at a location between the ends that engage the locking bolt and shackle respectively, thereby imparting movement of the locking bolt to the shackle and vice versa.

In accordance with another aspect of the invention there is provided a security lock for use with a lock unit, the security lock including:
a base;
a casing in which the base is, in use, received;
an elongate locking bolt which is movable between an first, operative position in which the bolt project from the base and a second, inoperative position in which the bolt is substantially withdrawn;
biasing means for biasing the locking bolt towards the withdrawn inoperative position;
an externally accessible operating member extending from the casing and cooperating with the locking bolt to move it against its bias from its inoperative to its operative position, wherein the operating member is substantially inaccessible or ineffective when the locking bolt is in its operative position;
a locking mechanism for retaining the locking bolt in its operative position, wherein the locking mechanism in use engages the lock unit such that unlocking of the lock unit releases the locking mechanism to allow the locking bolt to move from its operative position to its inoperative position under the action of the biasing means; and
a removable lock unit retaining and aligning formation for retaining and aligning the lock unit thereby to position the lock unit relative to the locking mechanism.

There is provided for the features of the security lock in accordance with the second aspect of the invention to the substantially similar to those of the security lock according to the first aspect of the invention.

### BRIEF DESCRIPTION OF THE DRAWINGS

The invention will now be described in more detail, by way of example only, with reference to the accompanying drawings in which:

FIG. 1 shows a top perspective view of a security lock in accordance with the invention;

FIG. 2 shows a front view of the security lock of FIG. 1;

FIG. 3 shows a rear view of the security lock of FIG. 1;

FIG. 4 shows a right side view of the security lock of FIG. 1;

FIG. 5 shows a bottom view of the security lock of FIG. 1;

FIG. 6 shows a top perspective view of the security lock of FIG. 1 in which the casing is removed;

FIG. 7 shows a rear view of the security lock of FIG. 1 in which the casing is removed;

FIG. 8 shows a rights side view of the security lock of FIG. 1 in which the casing is removed;

FIG. 9 shows a left side view of the security lock of FIG. 1 in which the casing is removed;

FIG. 10 shows a bottom view of the security lock of FIG. 1 in which the casing is removed;

FIG. 11 shows a top view of the security lock of FIG. 1 in which the casing is removed, wherein the locking pin is in its operative, locked position;

FIG. 12 shows a top view of the security lock of FIG. 1 in which the casing is removed, wherein the locking pin is in its inoperative, unlocked position;

FIG. 13 shows a cross-sectional side view of the security lock of FIG. 1 in which the securing mechanism is in its operative, secured position;

FIG. 14 shows a front view of the security lock of FIG. 1 in which the securing mechanism is in its operative, secured position;

FIG. 15 shows a perspective view of the casing of the security lock of FIG. 1;

FIG. 16 shows a perspective view of a lock retaining formation of the security lock of FIG. 1 in which the lock is shown;

FIG. 17 shows a bottom end view of the lock retaining formation of FIG. 16;

FIG. 18 shows a front view of the lock retaining formation of FIG. 16;

FIG. 19 shows a top end view of the lock retaining formation of FIG. 16;

FIG. 20 shows a perspective view of the lock retaining formation of FIG. 16 in which the lock is not shown;

FIG. 21 shows a front view of the lock retaining formation of FIG. 20;

FIG. 22 shows a right side view of the lock retaining formation of FIG. 20; and

FIG. 23 shows a top view of the lock retaining formation of FIG. 20.

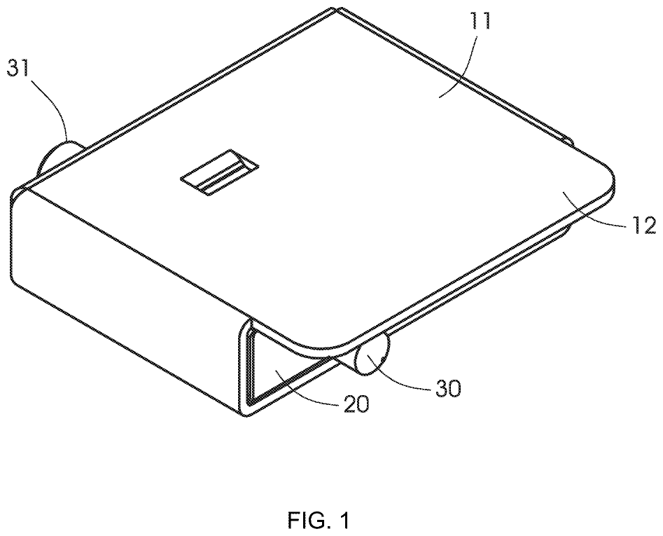

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “coupled” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of a security lock in accordance with the invention is generally indicated by reference numeral 10.

The security lock 10 according to the invention is in the form of a manually operable sliding bolt lock, which is locked by moving a locking bolt 30 into its operative, locked position by depressing an operating member 31 and unlocked using a key to unlock a lock unit 40.

The security lock 10 has a casing 11 which is typically carried by a hinged type security closure, such as a hinged door or gate (not shown). The casing 11 is typically made from steel and fixed to the door or gate by welding, for example. The casing 11 has an extended side wall portion 12, which creates a shield for shielding or concealing the locking interface between the securing lock 10 and the fixed construction which the security lock engages in its locked state. In the embodiment shown in the accompanying drawings the shield 12 creates a space adjacent it in which the fixed construction is received when the security lock 10 in use engages it in its locked state. The shield 12 prevents access to the locking bolt 30 in its operative, locked position, thereby preventing the bolt 30 from being compromised in order to compromise the security lock 10.

The casing 11 is shaped to receive an inner casing 20 in an internal cavity 13 defined by its side walls. The inner casing 20 carries the internal components of the security lock 10. The inner casing 20 is in the form of a base plate 20 that has an upstanding front wall 21 for mounting some of the internal components and for closing off access to the internal cavity 13 of the casing 11.

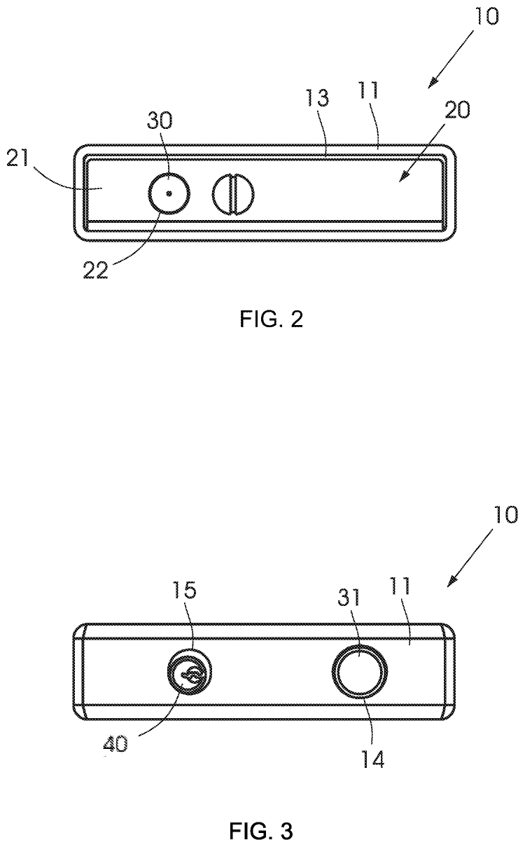

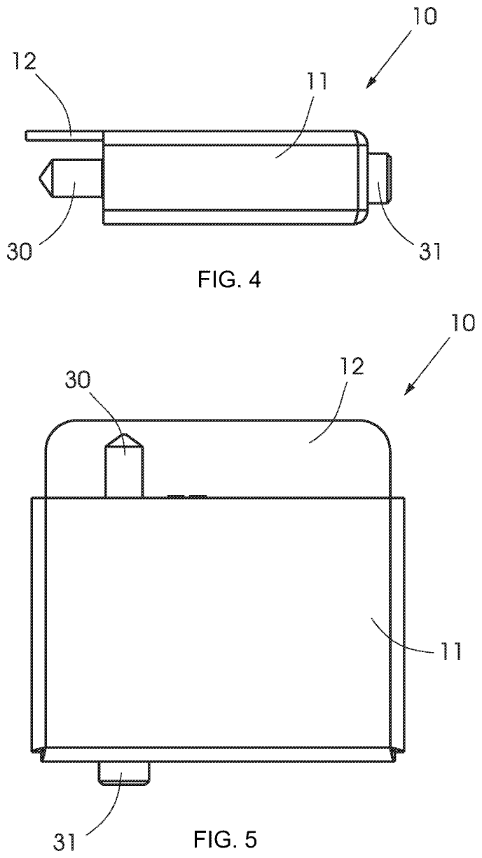

Best seen in FIGS. 2 to 5, in its operative, locked position the locking bolt 30 extend through a hole 22 in the upstanding wall 21 of the base plate 20. In a similarly manner, the operating member 31 extends through a hole 14 in the casing 11. Another hole 15 is provided in the casing 11 through which the key (not shown) of the locking unit 40 passes when unlocking the lock unit.

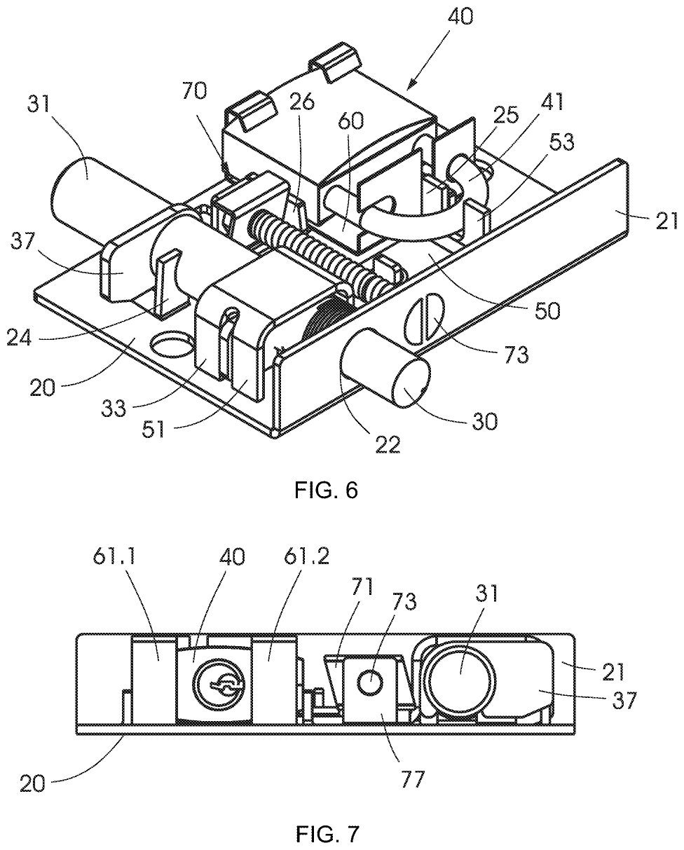

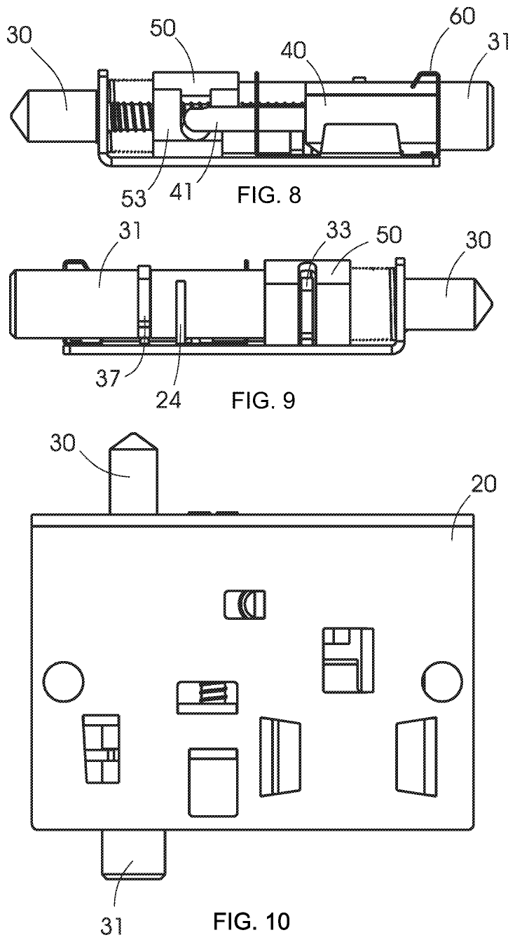

FIG. 6 shows a perspective view of the security lock 10 in which the casing 11 is removed in order to reveal the internal components of the security lock. From this figure it can be seen that the locking bolt 30 engages a locking mechanism 50 which, in turn, engages a shackle 41 of the lock 40 located in a lock unit retaining formation 60. A securing mechanism 70 is used to secure the inner casing or base plate 20 to the casing 11.

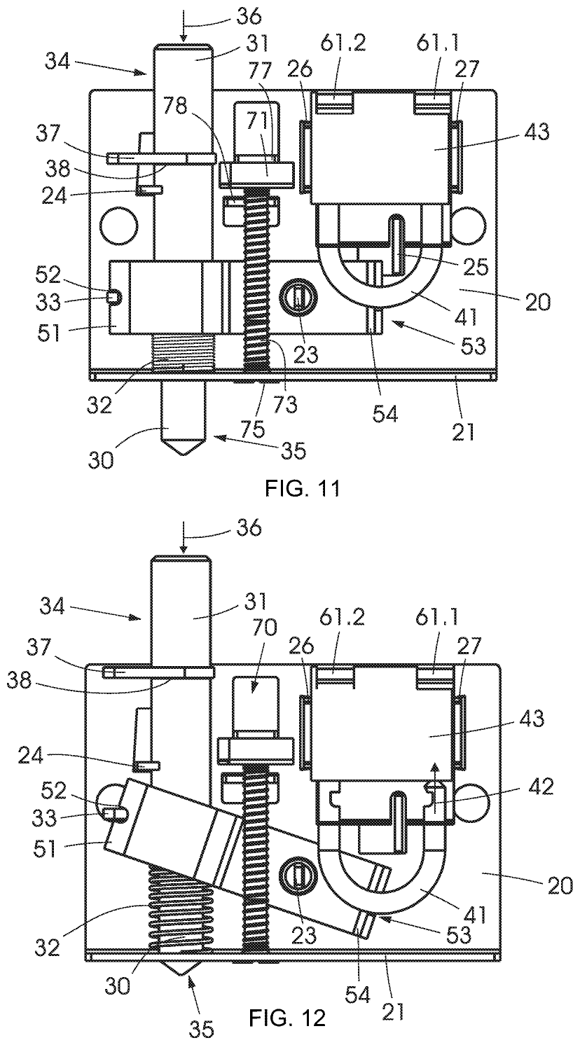

The locking bolt 30 is typically in the form of an elongate solid rod and is movable between a first, operative position in which the locking bolt 30 projects from the upstanding wall 21 of the base plate 20 and a second, inoperative position in which the locking bolt 30 is substantially withdrawn, i.e. do not extend significantly past the upstanding wall 21. The locking bolt 30 is shown in its operative, locked position in FIG. 11 and its inoperative, unlocked position in FIG. 12. For the sake of clarity, in the operative position the bolt 30 projects from the inner casing or base plate 20 and in the inoperative position the bolt 30 is substantively withdrawn into the inner casing 20. Although an end 35 is shown to protrude marginally beyond the front wall 21 in FIG. 11, it is envisaged that in an alternative embodiment not shown in the drawings that the end 35 could be located wholly within the base plate 20.

Returning now to the illustrated embodiment, biasing means such as a linear compression spring 32 is used to bias the locking bolt 30 towards its inoperative, withdrawn position, thereby ensuring that the locking bolt 30 is automatically withdrawn into its inoperative position when the security lock 10 is unlocked. The compression spring 32 is located between the upstanding front wall 21 of the base plate 20 and a locking mechanism engaging member 33 carried by the locking bolt 30. The engaging member 33 is in the form of a plate carried in a locating groove (not shown) in the locking bolt 30. The engaging member 33 is used to transfer the axial force exerted by the compression spring 32 to the locking bolt 30.

The engaging member 33 further engages the locking mechanism 50 so as to transfer movement of the locking bolt 30 to the locking mechanism and vice versa. An end 51 of the locking mechanism is shaped complementary to the engaging member 33 carried by the locking bolt 30. In the illustrated embodiment the end 51 of the locking mechanism 50 has a slot 52 in which the engaging member 33 is received.

The externally accessible operating member 31 is substantially in line with the locking bolt 30 and extends essentially in the opposite direction of the locking bolt 30. In the illustrated embodiment the operating member 31 is in the form of a sleeve, preferably cylindrical in shape, which is received about an end 34 of the locking bolt 30, which is opposite the end 35 extending through the upstanding front wall 21. The locking bolt 30 is typically designed such that its end 34 extends from the casing 11. However, it envisaged that in an alternative embodiment the locking bolt 30 itself may not extend from the casing but rather the sleeve 31 only.

In use, the locking bolt 30 is moved into its operative, locked position of FIG. 11 by pressing on the sleeve 31 in a direction indicated by the numeral 36. By depressing the sleeve 31 the force is transmitted to the engaging member 33 through contact between the sleeve 31 and the engaging member 33. This force acts to move the locking bolt 30 into its operative, locked position against the spring bias of spring 32 so as to extend the locking bolt 30 from the upstanding front wall 21. At the same time the securing mechanism 50 carried on the base plate 20 is pivoted about pivot element 23 located on the base plate. This pivotal movement can be seen in FIGS. 11 and 12.

The degree of movement of the locking bolt 30 and therefore the locking mechanism 50 is controlled or limited by limiting the movement of the sleeve 31. A stop 37 in the form of a stop formation, particularly a plate, is carried by the sleeve 31. In the illustrated embodiment the stop 37 is located in an annular groove 38 located on the sleeve 31. During depression of the sleeve 31, i.e. movement in the direction 36, the stop 37 locates against, or comes into contact with, a guide 24 located on the base plate 20. When unlocking the security lock 10 such that the locking bolt 30 is moved from its operative, locked position into its inoperative, unlocked position, the stop 37 locates against the internal surface of the casing 11 thereby limiting movement of the locking bolt 30 and, accordingly, the locking mechanism 50.

In addition to acting as a stop, the guide 24 engages an external surface of the sleeve 31 to guide movement of the sleeve, and accordingly the locking bolt 30, in a substantially linear movement. In other words, movement of the locking bolt 30 is essentially limited movement along its longitudinal axis.

In this illustrated embodiment of the security lock 10 the locking bolt 30 is manufactured as a single component, preferably from steel. The locking bolt 30 further has a uniform or constant diameter over substantially its entire length. In comparison to the known security locks the locking bolt 30 of the security lock 10 of the invention no longer requires an end cap made of aluminium. In contrast the portion end 35 of the bolt 30 extending beyond the front wall 21 when in the locked position is an integral part of, i.e. integrally formed with, the bolt 30 without the need for an end cap. It has been found that the unitary construction of the locking bolt 30 reduces manufacturing costs significantly.

Probably best illustrated in FIG. 11 and FIG. 12, movement of the locking bolt 30 is transferred to the shackle 41 of the lock unit 40 by means of the locking mechanism 50. The locking mechanism is in the form of a plate that carries a catch 53 at its end 54 that is opposite its other end 51 which engages the locking bolt 31. Probably best seen in FIG. 6 the catch 53 has an upstanding end section 54 carrying a slot 55 in which the shackle 41 is received.

By engaging the locking bolt 30 at its end 51 and the shackle 41 at its end 54 the connecting mechanism 50 translates axial movement of the locking bolt 30 into axial movement of the shackle 41 by pivoting about pivot 23. The axial movement of the shackle 41 is in substantially the opposite direction of movement of the locking bolt 30. Depression of the locking bolt 30 therefore causes the shackle 41 to move in the direction 42 towards the body 43 of the lock unit 40, thereby locking the lock unit. In its locked state the lock unit 40 holds the catch 53 captive in the position shown in FIG. 12 in order to lock the locking bolt 30 in its operative, locked position. To unlock the security lock 10 the key (not shown) of the lock unit 40 is used to unlock the shackle 41 thereby allowing the locking mechanism 40 to pivot about the pivot 23 such that the locking bolt is allowed to move into its operative, unlocked position under bias of the spring 32.

In order to facilitate smooth movement of the locking bolt 30, the locking mechanism 50 and the shackle 41 it is important for the locking units 40 to be aligned accurately on the base plate 20. For this reason, the lock unit 40 is housed or retained in a lock unit retaining and aligning formation 60, which is in the form of a metal plate housing in the illustrated embodiment.

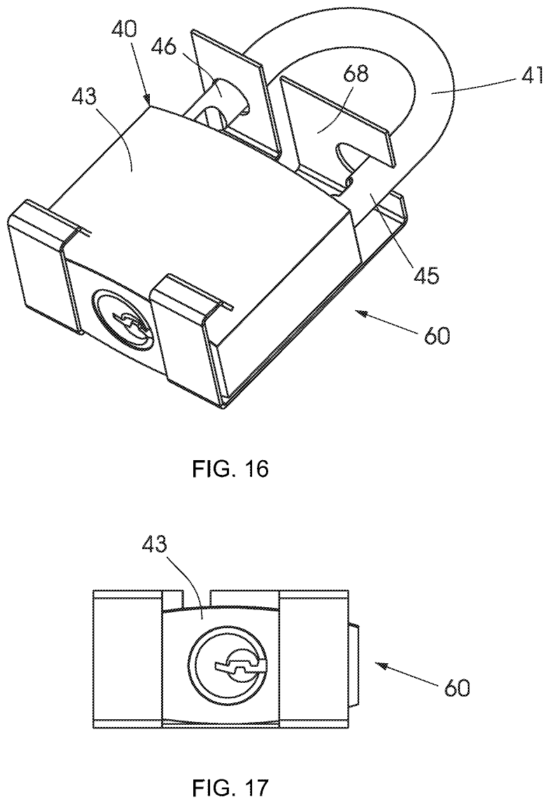

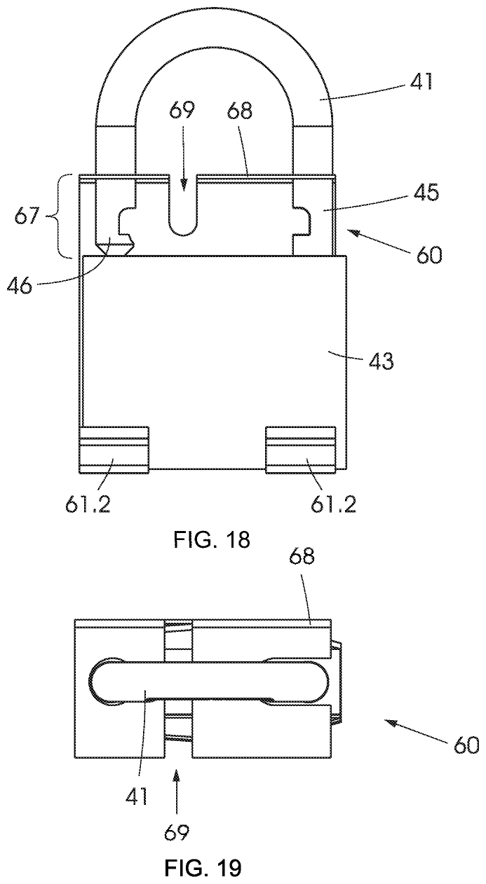

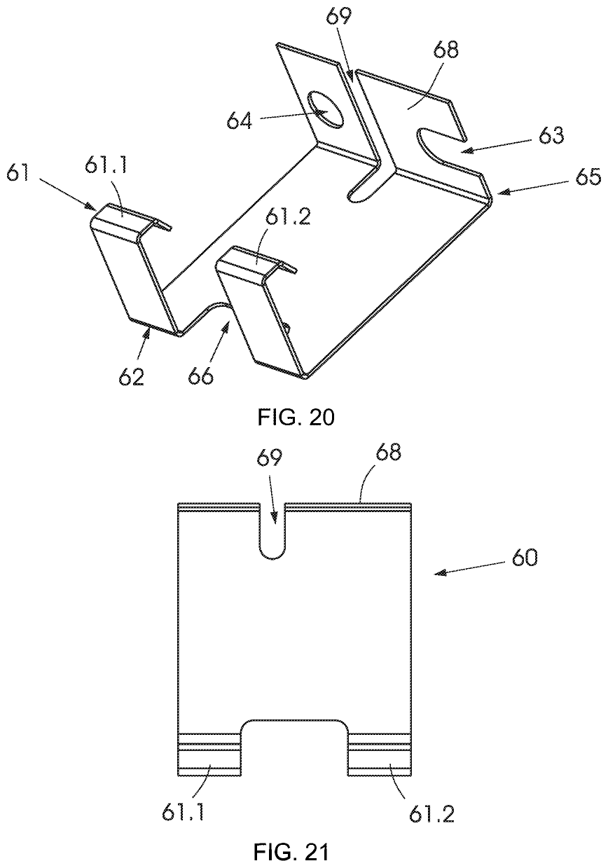

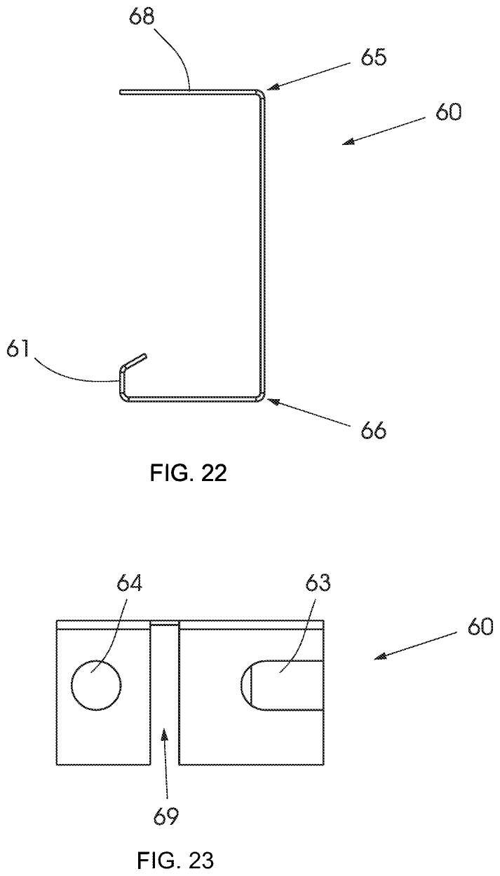

The housing 60 is shown in detail in FIGS. 16 to 23, and is shaped to receive and retain the lock 40. In addition to receiving and retaining the lock unit 40, the housing 60 align it, particularly the shackle 41, relative to the locking mechanism 50. In the illustrated embodiment the housing as manufactured from single piece of sheet metal which is bent to create lock unit engaging means for engaging and securing the lock to the housing 60.

The retaining means includes at least one lip 61 carried at one end 62 of the housing and a pair of recesses 63 and 64 carried at a second opposite end 65 of the housing 60. The housing 60 has a cut-out 66 which creates two retaining lips 61.1 and 61.2 which engage the body 43 of the lock unit 40. In use, the key of the lock unit 40 passes between the two legs 61.1 and 61.2 to engage the keyhole 44.

At the end 65 of the housing 60 the recesses 63 and 64 are shaped to receive the respective ends 45 and 46 of the shackle 41. The one recess 63 is the form of a slot for receiving the fixed end 45 of the shackle 41 while the other recess 64 is in the form of a hole for receiving the free end 46 of the shackle 41. The housing 60 is shaped such that the free end 46 of the shackle 41 is located in the hole 64 in both the locked and unlocked states of the lock unit 40, thereby preventing any misalignment that might otherwise have resulted through unwanted rotation of the shackle 41.

In order to allow the locking unit 40 to be inserted into and removed from the housing 60 sufficient headspace 67 is provided for between the body 41 of the lock unit 40 and the upstanding end piece 68 in which the slot 63 and hole 64 are located. The lock 40 is inserted into the housing 60 from its side to which the recess 63 is open. The body 43 of the lock 40 is inserted into the housing 60 by sliding it into the body from the side. The body 43 of the lock 40 essentially slides along the end section 68 such that the end section 68 is located in the gap between the free end 46 of the shackle 41 and the body 43. The body 43 of the lock 40 is moved into the housing 60 until the fixed and 45 of the shackle 41 is received in the recess 63 and the free end 46 of the shackle 41 is aligned with the hole 64. The body 43 of the lock 40 is then moved towards the end 62, thereby locating the free end 46 in the hole 64 of the end section 68. In this position the housing 60 a secured to the lock 40.

The housing 60 is located on the base plate 20 by means of complementary shaped locating formations carried on the housing and base plate respectively. The housing 60 has a cut-out or slot 69 for receiving the locating formation in the form of an upstanding guide 25 located on the base plate 20.

Additional locating formations in the form of upstanding guides 26 and 27 are located on the base plate 20 such that they locate the sides of the housing 60 and accordingly the body 43 of the lock 40. The housing 60 and lock 40 is therefore located by the three guides 25, 26 and 27 on the base plate 20. It should be understood that the side walls of the casing 11 further assist in locating the housing 60 and lock 40 in position.

The use of the housing 60 provides a significant advantage by allowing for tolerances in dimensions of the lock unit 40. The housing 60 allows from movement of the lock unit 40 inside the housing 40 while maintaining alignment with the securing mechanism 50 to achieve reliable operating of the security lock 10. The lock unit 40 could therefore be replaced more easily as and when required.

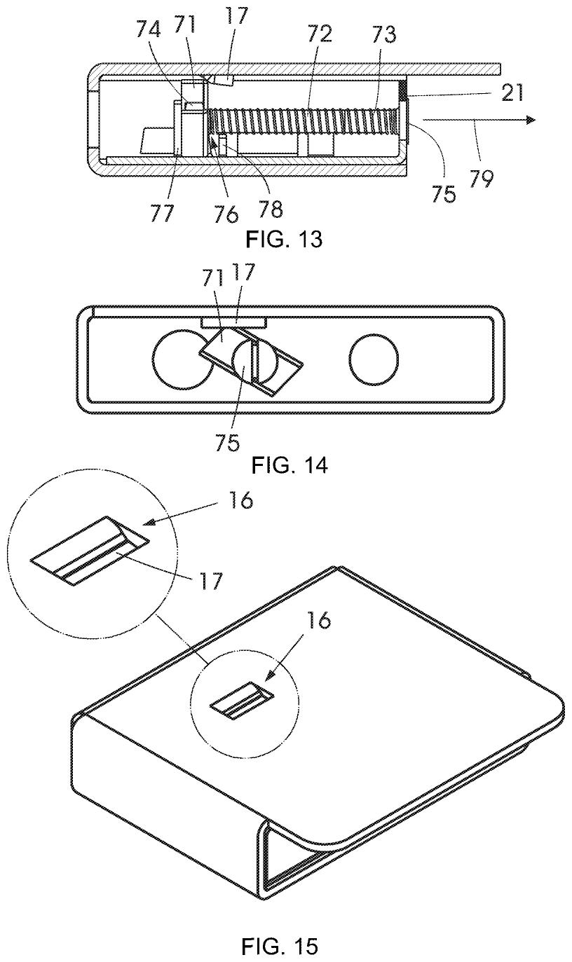

Turning now in particular to FIGS. 11 to 15 a securing mechanism 70 of the security lock 10 will be described. The securing mechanism 70 in use secures the base plate 20 within the casing 11, thereby preventing access to the internal components of the security lock 10. The securing mechanism 70 and casing 11 carry complementary shaped securing formations which secure the base plate 20 in the casing 11 when they engage each other and allows the base plate 20 to be removed from the casing 11 when they are disengaged.

The securing formation carried on the base plate 11 is in the form of a substantially U-shaped channel section 71 which is held captive on a securing element, which in this embodiment is in the form of a threaded bar 72, between an end of a biasing member in the form of a spring 73 and a nut 74 threaded on the bar 72. The threaded bar 72 is typically a fastener such as a bolt. An end 75 of the bolt, which carries the head of the bolt for engagement with a hand tool such as a screw driver, is in use located outside the casing 11. The head 75 locates against the upstanding front wall 21. The opposite end 76 of the bolt 73 is located in an upstanding plate 77. In particular, the plate 77 carries a threaded hole in which the end 76 of the bolt 73 is threaded. The bolt 73 is therefore held between the front wall 21 and the plate 77. A second upstanding plate 78 acts like a stop to limit the movement of the bolt 73 in an axial direction. When moving the bolt 73 in an axial direction 79 to remove it from the hole in the front wall 21, movement of the channel section 71 is obstructed by the stop plate 78. In other words, the stop plate 78 obstructs the channel section 71 from moving in the axial direction 79, thereby holding it captive between the plates 77 and 78. It should be understood that the spring 73 biases the fastener 73 in an axial direction into the casing 11 and base plate 20, i.e. in a direction opposite the direction 79.

The bolt 73 is however allowed at least partial rotational movement, typically by using a screw driver (not shown) to rotate its head 75. The nut 74 located about the bolt 73 in a position between the two legs of the U-shaped channel section 71 is dimensioned so as to impart its rotational movement to the channel section 71. Rotation of the bolt 73 and nut 74 therefore causes the channel section 71 to rotate between a first, locked position wherein it engages the securing formation located on the casing 11 and a second, free position in which it is disengaged from the securing formation located on the casing.

Best seen in FIG. 15 the locating formation on the casing 11 is created by a notch 16 such that a piece of the side wall extends into the casing 11. The piece of the side wall is indicated by the reference numeral 17. From the above description it should be clear that rotation of the bolt 73 causes the channel section 71 to rotate between a first radial position in which it engages the piece of side wall 17 to secure the base plate 20 to the casing 11 and a second radial position in which it is free from the piece of side wall 17 to release the base plate 20 from the casing 11.

An advantage of the securing mechanism 70 of the invention is that the fastener 73 remains in position on the base plate 20. In other words, the fastener 73 is never separated from the base plate 20. This is a significant advantage consider the time spent in reassembling prior art security locks where the fastener is completely released and therefore separated from the base plate. There is thus a significant time saving when assembling the lock during installation or after having replaced the lock 40, for example. Another advantage is that the fastener 73 only requires limited rotation to lock or release the base plate 20 to the casing 11. In this invention the securing mechanism 70 is released or locked through a partial revolution of the fastener 73, thereby again facilitating quick and easy assembly and disassembly of the security lock. The securing mechanism 70 therefore addresses a longstanding problem that many user and installers of the prior art locking devices have encountered. This is achieved by holding the end 76 of the securing element 72 captive on the complementary shaped retaining formation located on the base plate 20. It should therefore be understood that by using the security lock 10 it is no longer required to locate the end of the security element inside a retaining formation, such as a threaded plate or nut, blindly.

It will be appreciated that the above description only provides example embodiments of the invention and that there may be many variations without departing from the spirit and/or the scope of the invention. It is easily understood from the present application that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1. A security lock for use with a lock unit, the security lock including:
a base;
a casing in which the base is, in use, received;
an elongate locking bolt which is movable between an first, operative position in which the bolt projects from the base and a second, inoperative position in which the bolt is substantially withdrawn;
biasing means for biasing the locking bolt towards the withdrawn inoperative position;
an externally accessible operating member extending from the casing and cooperating with the locking bolt to move it against its bias from its inoperative to its operative position, wherein the operating member is substantially inaccessible or ineffective when the locking bolt is in its operative position;
a locking mechanism for retaining the locking bolt in its operative position, wherein the locking mechanism in use engages the lock unit such that unlocking of the lock unit releases the locking mechanism to allow the locking bolt to move from its operative position to its inoperative position under the action of the biasing means; and
a securing mechanism for securing the base to the casing,
wherein the securing mechanism includes a securing element which is operable to move the securing mechanism between a locked state in which the base and casing are locked to each other and a released state in which the base and casing are released from each other,
wherein the securing element is held captive such that it remains in position irrespective of whether the securing mechanism is in its locked or released state.

2. A security lock according to claim 1, wherein the securing mechanism includes complementary shaped securing formations carried on the base and casing respectively such that relative movement between the securing formations in one direction secures the base and casing together and relative movement in the opposite direction releases the base from the casing.

3. A security lock according to claim 2, wherein the securing formation carried by the base is held captive on the securing element such that rotation of the securing element in one direction causes rotation of the securing formation located on the base so as to engage the securing formation carried by the casing and rotation of the securing element in the opposite direction causes rotation of the securing formation carried by base in a direction releasing the securing formation from the securing formation carried by the casing.

4. A security lock according to claim 2, wherein the securing element is in the form of a threaded fastener which is held captive by a threaded nut located thereon, and in that rotation of the nut on the fastener is obstructed by the securing formation carried by the base.

5. A security lock according to claim 4, wherein the securing formation on the base is in the form of a substantially U-shaped channel section which is held captive on the threaded fastener between a spring and the nut threaded on the fastener.

6. A security lock according to claim 5, wherein the U-shaped channel section is shaped to allow partial rotation about the threaded fastener such that it engages the securing formation carried by the casing in one radial position and disengages the securing formation carried by the casing in another radial position.

7. A security lock according to claim 4, wherein the threaded fastener is a bolt or screw, one end of which is secured in a threaded upstanding receiver plate located on the base and the other end is located on the outside of the upstanding front wall of the base such that the securing mechanism is operable from outside the casing.

8. A security lock according to claim 1, including a lock unit retaining and aligning formation for retaining and aligning the lock unit relative to the locking mechanism, wherein the lock retaining formation is in the form of a metal plate housing, wherein the metal housing has lock unit engaging means for engaging and securing the lock unit to the housing, and wherein the lock unit engaging means is in the form of a lip carried at one end of the housing and a pair of recesses carried at a second opposite end of the housing.

9-12. (canceled)

13. A security lock according to claim 8, wherein the one recess is in the form of a slot for receiving a fixed end of a shackle of the lock unit while the other recess is in the form of a hole for receiving a free end of the shackle of the lock unit when the lock unit is in its locked state.

14. A security lock according to claim 13, wherein the metal housing and base carry complementary shaped locating formations for locating the housing on the base.

15. A security lock according to claim 14, wherein the locating formation on the metal housing is in the form of a cut-out for receiving the locating formation in the form of an upstanding guide located on the base.

16. A security lock according to claim 1, wherein the locking bolt is in the form of a single component.

17. (canceled)

18. A security lock according to claim 1, including a guide located on the base for guiding movement of the locking bolt.

19. A security lock according to claim 18, wherein the operating member carries a stop formation for limiting its movement and, accordingly, the movement of the locking bolt, and in that the stop formation locates against the guide located on the base to limit movement of the locking bolt into its operative, locked position and locates against the internal surface of the casing to limit movement of the locking bolt into its inoperative, unlocking position.

20. A security lock for use with a lock unit, the security lock including:
a base;
a casing in which the base is, in use, received;
an elongate locking bolt which is movable between an first, operative position in which the bolt projects from the base and a second, inoperative position in which the bolt is substantially withdrawn;
biasing means for biasing the locking bolt towards the withdrawn inoperative position;
an externally accessible operating member extending from the casing and cooperating with the locking bolt to move it against its bias from its inoperative to its operative position, wherein the operating member is substantially inaccessible or ineffective when the locking bolt is in its operative position;
a locking mechanism for retaining the locking bolt in its operative position, wherein the locking mechanism in use engages the lock unit such that unlocking of the lock unit releases the locking mechanism to allow the locking bolt to move from its operative position to its inoperative position under the action of the biasing means; and
a removable lock unit retaining and aligning formation for retaining and aligning the lock unit relative to the locking mechanism.

21. A security lock according to claim 20, wherein the lock retaining formation is in the form of a metal plate housing, which has lock unit engaging means for engaging and securing the lock unit to the housing.

22. A security lock according claim 21, wherein the engaging means is in the form of a lip carried at one end of the housing and a pair of recesses carried at a second opposite end of the housing, and in that the recesses are shaped to receive a shackle of the lock unit.

23. A security lock according to claim 20, including a securing mechanism for securing the base to the casing, wherein the securing mechanism includes a securing element which is operable to move the securing mechanism between a locked state in which the base and casing are locked to each other and a released state in which the base and casing are released from each other, and wherein the securing element is held captive such that it remains in position irrespective of whether the securing mechanism is in its locked or released state.

24. A security lock according to claim 23, wherein the securing mechanism includes complementary shaped securing formations carried on the base and casing respectively such that relative movement between the securing formations in one direction secures the base and casing together and relative movement in the opposite direction releases the base from the casing.

25. A security lock according to claim 24, wherein the securing formation carried by the base is held captive on the securing element such that rotation of the securing element in one direction causes rotation of the securing formation located on the base so as to engage the securing formation carried by the casing and rotation of the securing element in the opposite direction causes rotation of the securing formation carried by base in a direction releasing the securing formation from the securing formation carried by the casing.
